(19) United States
(12) Patent Application Publication
(10) Pub. No.: US 2014/0376125 A1
(43) Pub. Date: Dec. 25, 2014

(54) CONTROL SYSTEM FOR HARD DISKS

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: MIN ZHOU, Shenzhen (CN); HUI LI, Shenzhen (CN)

(21) Appl. No.: 14/313,418

(22) Filed: Jun. 24, 2014

(30) Foreign Application Priority Data
Jun. 24, 2013 (CN) 201310250687X

(51) Int. Cl. G11B 19/20

(52) U.S. Cl. CPC G11B 19/209; G11B 19/2054
USPC 360/73.03

(57) ABSTRACT

A control system for a group of hard disks includes a power supply and a connecting module. The power supply supplies power for the group of hard disks. The connecting module couples the power supply to the group of hard disks. The group of hard disks has a number of hard disks. When the connecting module is coupled between the power supply and the group of hard disks, a staggering spin-up function of the plurality of hard disks is activated.

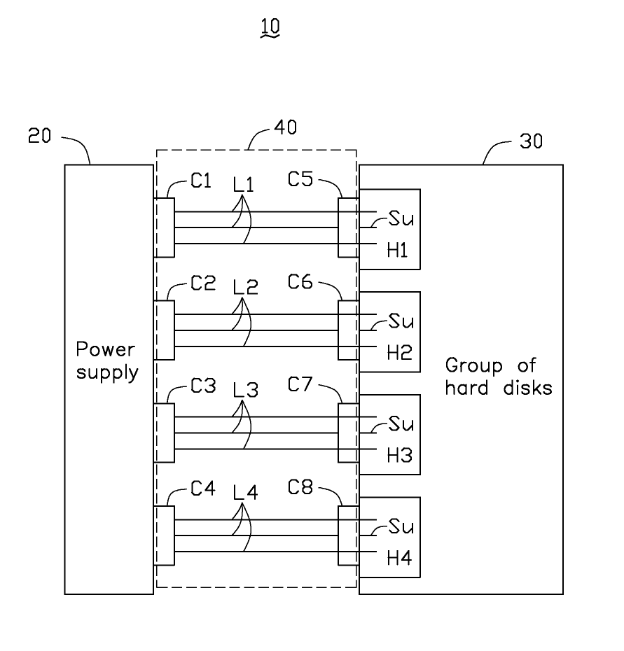

### FIELD

The subject matter herein generally relates to a control system for a plurality of hard disks.

### BACKGROUND

A device may comprise at least one hard disk.

### BRIEF DESCRIPTION OF THE DRAWINGS

Implementations of the present technology will now be described, by way of example only, with reference to the attached figures, wherein:

The drawing is a block diagram of an embodiment of a control system for hard disks.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a control system 10.

The drawing illustrates the control system 10. The control system 10 can comprise a power supply 20, a group of hard disks 30, and a connecting module 40.

The group of hard disks 30 can comprise a first hard disk H1, a second hard disk H2, a third hard disk H3, and a fourth hard disk H4 or more. Each of the first hard disk H1, the second hard disk H2, the third hard disk H3, and the fourth hard disk H4 has a power connector. The power connectors of the first hard disk H1, the second hard disk H2, the third hard disk H3, and the fourth hard disk H4 are coupled to the power supply 20 through the connecting module 40. Each of the power connectors has a control pin Su. The control pin Su can control a function of the hard disks. In the embodiment, a staggered spin-up function of the hard disk is activated when the control pin Su is at a high level, such as logic 1 or is idle. The staggered spin-up function of the hard disks is deactivated when the control pin Su is at a low level, such as logic 0.

The connecting module 40 can comprise a first cable L1, a second cable L2, a third cable L3, and a fourth cable L4. The first cable L1 is coupled to the power supply 20 through a first connector C1 and is coupled to the first hard disk H1 through a second connector C5. The second cable L2 is coupled to the power supply 20 through a first connector C2 and is coupled to the second hard disk H2 through a second connector C6. The third cable L3 is coupled to the power supply 20 through a first connector C3 and is coupled to the third hard disk H3 through a second connector C7. The fourth cable L4 is coupled to the power supply 20 through a first connector C4 and is coupled to the fourth hard disk H4 through a second connector C8.

The second connectors C5-C8 have no pins coupled to the control pins Su. Thus, the control pins Su of the hard disks 30 are idle. The staggered spin-up function of the hard disks 30 is activated.

The embodiment shown and described above is only one example according to the disclosure. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A control system for a group of hard disks, the control system comprising:
a power supply configured to supply power for the group of hard disks; and
a connecting module, wherein the connecting module is coupled between the power supply and the group of hard disks, the group of hard disks has a plurality of hard disks, a staggering spin-up function of the plurality of hard disks is activated when control pins of the plurality of hard disks receive a first signal, the staggering spin-up function of the plurality of hard disks is deactivated when the control pins of the plurality of hard disks receive a second signal.

2. The control system of claim 1, wherein the first signal is a high level signal, and the second signal is a low level signal.

3. The control system of claim 2, where in when the connecting module is coupled between the power supply and the group of hard disks, the control pins of the plurality of hard disks are idle.

4. A control system for a group of hard disks, the control system comprising:
a power supply configured to supply power for the group of hard disks; and
a connecting module coupled between the power supply and the group of hard disks,
wherein the group of hard disks includes a plurality of hard disks, a staggering spin-up function of the plurality of hard disks is configured to be activated when control pins of the plurality of hard disks receive a first signal and is configured to be deactivated when the control pins of the plurality of hard disks receive a second signal.
